(19) United States
(12) Patent Application Publication
(10) Pub. No.: US 2016/0381710 A1
(43) Pub. Date: Dec. 29, 2016

(54) System and Methods for Using a Radio Frequency Resource to Improve Performance on a Data Communication in a Multi-Subscriber Identity Module (SIM) Wireless Communication Device

(71) Applicant: QUALCOMM Incorporated, San Diego, CA (US)

(72) Inventors: Pankaj Bansal, Jaipur (IN); Siddhant Mehrotra, Raleigh, NC (US); Ravi Kanth Kotreka, Hyderabad (IN)

(21) Appl. No.: 14/753,798

(22) Filed: Jun. 29, 2015

(51) Int. Cl. H04W 74/08; H04W 68/00; H04W 72/04

(52) U.S. Cl. CPC H04W 74/0833; H04W 72/0446; H04W 68/00; H04W 88/06

(57) ABSTRACT

In a multi-subscription wireless communication device with a shared radio frequency (RF) resource, when there is an active data communication associated with the first SIM, a tune-away may be performed to support a subscription on a second SIM. After tuning to the second network to receive data during an assigned time slot in a frame capable of carrying a common control channel the wireless communication device may determine whether a message granting or denying the requested channel access can be recovered or excluded, and skip receiving remaining frames for the message and stop tune-aways when a message granting the requested channel access can be excluded. In some embodiments determining whether the message can be excluded may include determining whether a signal-to-noise ratio for the received data burst is greater than 10 dB, and if so, determining whether the decoded data can be identified as part of a paging message.

### BACKGROUND

Multi-subscriber identity module (SIM) wireless communication devices have become increasing popular because of their flexibility in service options and other features. One type of multi-SIM wireless communication device, a multi-SIM multi-standby (MSMS) wireless communication device (e.g., a dual-SIM dual-standby (DSDS) wireless communication device), enables two SIMs to be in idle mode waiting to begin communications, but only allows one SIM at a time to participate in an active communication due to sharing of a single radio frequency (RF) resource (e.g., a transceiver). Other multi-SIM wireless communication devices may extend this capability to more than two SIMs and may be configured with any number of SIMs greater than two (i.e., multi-SIM multi-standby wireless communication devices).

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Mobile Telecommunications System (UMTS) Terrestrial Radio Access Network (UTRAN). The UTRAN is the radio access network (RAN) defined as a part of the UMTS, a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (WCDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

Since an MSMS wireless communication device typically uses a single RF resource to communicate over the multiple SIMs and/or networks, the device can only actively communicate using a single SIM and/or network at a given time. As such, with an active data communication on one SIM (e.g., the first SIM), the wireless communication device may periodically tune away to a network associated with another SIM (e.g., the second SIM) to monitor signals or acquire a connection. As a result, even when no channel access is ultimately granted to the second SIM, the performance for the data communication on the network supported by the first SIM may be degraded.

### SUMMARY

Systems, methods, and devices of various embodiments may enable a wireless communication device configured to use at least a first SIM and a second SIM associated with a shared radio frequency (RF) resource to improve data throughput. The various methods may include detecting an active data communication in a first network on a modem stack associated with the first SIM, detecting a channel access request on a modem stack associated with the second SIM, identifying an assigned time slot for receiving a message on a common control channel from a second network supported by the second SIM, tuning to the second network to receive and decode data during the assigned time slot in at least one frame capable of carrying the common control channel, tuning back to the first network following the assigned time slot in each of the at least one frame, and determining, after each assigned time slot, whether a message granting or denying the channel access request can be recovered or excluded based on the data that has been received and decoded. Some embodiments may further include skipping receiving and decoding of remaining frames of the message on the common control channel in response to determining that a message granting the channel access request can be excluded, and stopping tuning to the first network in response to determining that a message granting the channel access request is recovered.

In some embodiments, determining whether the message can be excluded may include determining whether signal-to-noise ratio for at least one received data burst is greater than 10 dB, and determining whether the data that has been received and decoded can be identified as part of a paging message in response to determining that the signal-to-noise ratio for the at least one received data burst is greater than about 10 dB. In such embodiments, determining whether the data that has been received and decoded can be identified as part of a paging message may include identifying information provided in message fields in the data that has been received and decoded, and comparing the identified information to values classifying at least one paging message type. In such embodiments, the message fields may include a skip indicator, a protocol discriminator, and a message type, and the values classifying the at least one paging message type may include a first 8-bit value identifying radio resource management communications, and a second 8-bit value identifying one of a paging message type 1-3. Some embodiments may further include repeating the receiving and decoding of data for a next frame capable of carrying the common control channel in response to determining that a signal-to-noise ratio for the at least one received data burst is not greater than about 10 dB or that the data that has been received and decoded is not identified as part of a paging message.

In some embodiments, detecting a channel access request on a modem stack associated with the second SIM may include detecting transmission of a request on a random access channel (RACH) to the second network. In some embodiments, the message granting the channel access request is an immediate assignment (IA) message received on an access grant control channel from the second network. In some embodiments, the message denying the channel access request may be an IA rejection message received on an access grant control channel from the second network. In some embodiments, the at least one frame capable of carrying the common control channel may include one to four time division multiple access (TDMA) frames.

Various embodiments include a wireless communication device configured to use at least a first subscriber identity module (SIM) and a second SIM associated with a shared RF resource, and including a processor configured with processor-executable instructions to perform operations of the methods described above. Various embodiments also include a non-transitory processor-readable medium on which is stored processor-executable instructions configured to cause a processor of a wireless communication device to perform operations of the methods described above. Various embodiments also include a wireless communication device having means for performing functions of the methods described above.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a communication system block diagram of a network suitable for use with various embodiments.

FIG. 2 is a block diagram illustrating a wireless communications device according to various embodiments.

FIG. 3 is a system architecture diagram illustrating example protocol layer stacks implemented by a wireless communication device.

FIGS. 4A and 4B are process flow diagrams illustrating a method for improving performance of communications on different SIMs in a multi-SIM wireless communication device according to various embodiments.

FIG. 5 is a component diagram of an example wireless communication device suitable for use with various embodiments.

FIG. 6 is a component diagram of another example wireless communication device suitable for use with various embodiments.

### DETAILED DESCRIPTION

Various embodiments will be described in detail with reference to the accompanying drawings. Wherever possible the same reference numbers will be used throughout the drawings to refer to the same or like parts. References made to particular examples and implementations are for illustrative purposes, and are not intended to limit the scope of the claims.

Various embodiments provide methods and apparatuses for improving performance of communications associated with different SIMs in a wireless communication device configured with a shared RF resource.

In some wireless communication devices, a message may be sent to a network on a random access channel (RACH) in order to request use of dedicated communication resources. Following the RACH request, the wireless communication device may monitor the network during a timeslot assigned to the group to which the SIM belongs to receive a message on an access grant channel (AGCH). The message may be, for example, an immediate assignment message or an immediate assignment rejection. Specifically, such monitoring may involve receiving and decoding data during that timeslot over four consecutive TDMA frames that carry a common control channel (CCCH).

Various embodiments may allow for a data communication session on a first network to be maintained while still monitoring the appropriate control channel for an access message on a second network. Various embodiments provide techniques that improve tune-aways to the second network for monitoring the access grant channel for the second SIM group, as well as selectively decoding the received data bursts to recover an immediate assignment message intended for the second SIM. Together, such techniques may enhance data throughput and performance on the first network without sacrificing the capability to receive channel access on the network associated with the second SIM.

That is, an active data communication may be maintained on a network associated with the first SIM of a multi-SIM multi-standby (MSMS) wireless communication device while a shared RF resource is used to receive and decode data from a network associated with the second SIM during a specified timeslot of TDMA frames that carries, among other control channels, an access grant channel. In particular, the wireless communication device in various embodiments may detect, during the data communication on a first SIM, a channel access request for the second SIM (e.g., a RACH request for a mobile originating call or to transmit uplink data packets). Typically, the wireless communication device may tune to the network associated with the second SIM, and decode data received over four consecutive TDMA frames during a timeslot assigned to the group to which the second SIM belongs in order to receive an immediate assignment message or immediate assignment rejection. In various embodiments, the wireless communication device may minimize unnecessary tune-away time within the sequence of four TDMA frames by performing single burst tune-aways to the network associated with the second SIM for only the assigned timeslot, and tuning back to the network associated with the first SIM for the remaining timeslots.

Also, the wireless communication device may employ techniques to attempt to determine as early as possible within the sequence of four TDMA frames whether the received data is part of a message that is not an access grant channel message. If the wireless communication device is not able to determine whether the received data is part of a message that is not an access grant channel message, the wireless communication device may determine whether the decoded information from the received data is sufficient to recover a complete message on the access grant channel for the second SIM. In either case, the wireless communication device may stop performing the tune-aways until the next message opportunity on the second SIM. For example, if the signal-to-noise ratio is greater than about 10 dB (e.g., 9-11 dB), the wireless communication device can determine whether each decoded burst can be identified as part of a paging request message based on whether fields that classify layer 3 messages correspond to any of the paging request types. If a burst cannot be identified as part of a paging request message, the wireless communication device may determine whether the message can be recovered from the bursts decoded so far, and if so, the wireless communication device may stop performing the tune-aways and burst decoding.

If the message cannot yet be recovered, the wireless communication device may again tune back to the network associated with the first SIM until the next appropriate timeslot, at which point the wireless communication device may start another tune-away and decode the next burst. In this manner, bursts may be individually evaluated to minimize the amount of time needed to identify messages as being either irrelevant or relevant, and/or recover a complete message, thereby maximizing the amount of time that the shared RF resource is tuned to the communication on the first SIM.

The terms “wireless communication device,” “user equipment,” and “mobile device” are used interchangeably herein to refer to any one or all of cellular telephones, smart phones, personal or mobile multi-media players, personal data assistants (PDAs), laptop computers, tablet computers, smart books, palm-top computers, wireless electronic mail receivers, multimedia Internet enabled cellular telephones, wireless gaming controllers, and similar personal electronic devices that include a programmable processor and memory and circuitry for establishing wireless communication pathways and transmitting/receiving data via wireless communication pathways.

As used herein, the terms “subscription,” “SIM,” “SIM card,” and “subscriber identification module” are used interchangeably to mean a memory that may be an integrated circuit or embedded into a removable card, which stores an International Mobile Subscriber Identity (IMSI), related key, and/or other information used to identify and/or authenticate a wireless communication device on a network. Examples of SIMs include the Universal Subscriber Identity Module (USIM) provided for in the LTE 3GPP standard, and the Removable User Identity Module (R-UIM) provided for in the 3GPP2 standard. Universal Integrated Circuit Card (UICC) is another term for SIM.

The terms subscription and SIM may also be used as shorthand reference to a communication network associated with a particular SIM, since the information stored in a SIM enables the wireless communication device to establish a communication link with a particular network, thus the SIM and the communication network, as well as the services and subscriptions supported by that network, correlate to one another.

As used herein, the terms “multi-SIM wireless communication device,” “dual-SIM wireless communication device,” “dual-SIM dual-standby device,” and “DSDS device” are used interchangeably to describe a wireless communication device that is configured with more than one SIM and allows idle-mode operations to be performed on two networks simultaneously, as well as selective communication on one network while performing idle-mode operations on the other network.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (WCDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

In some wireless networks, a wireless communication device may have multiple subscriptions to one or more networks (e.g., by employing multiple subscriber identity module (SIM) cards or otherwise). Such a wireless communication device may include, but is not limited to, a dual-SIM dual-standby (DSDS) device. For example, a first subscription may be a first technology standard, such as WCDMA, while a second subscription may support the same technology standard or a second technology standard, such as GSM Enhanced Data rates for GSM Evolution (EDGE) (also referred to as GERAN).

A multi-SIM wireless communication device that supports two or more SIMs may have a number of capabilities that provide convenience to a user, such as allowing different wireless carriers, plans, telephone numbers, billing accounts, etc. on one device. Developments in multi-SIM wireless communication device technology have led to a variety of different options for such devices. For example, an “active dual-SIM” wireless communication device allows two SIMs to remain active and accessible to the device. In particular, a type of active dual-SIM wireless communication device may be a “dual-active dual standby” (DSDS) wireless communication device in which two SIMs are configured to share a single transceiver (i.e., RF resource).

In current mobile communications, wireless service carriers have standardized a number of techniques for selecting wireless communications systems and obtaining service therefrom, in accordance with preferences of the subscriber's service provider/carrier. Service providers generally enable subscribers to access a network by providing provisioning information to subscriber devices. For clarity, the embodiments are described below for GSM-type and/or UMTS-type networks, but may be applied to networks using any other radio technology or protocol.

An example GSM network may operate on any of a number of GSM bands (e.g., GSM 900, GSM 850, etc.), each of which cover multiple radio frequency (RF) channels identified by absolute radio frequency channel numbers (ARFCNs). The ARFCNs for various GSM bands are given in 3GPP TS 05.05, entitled “Digital cellular telecommunications system (Phase 2+); Radio transmission and reception (Release 1999).” Further, each GSM network typically operates on a specific set of RF channels in a specific GSM band.

In describing various embodiments, the terms “channel,” “frequency,” and “ARFCN” may be used interchangeably and may refer to channels in GSM bands, and/or channels in other network bands (e.g., UARFCNs for UMTS networks, LTE EARFCNs for LTE networks, etc.).

The SIMs in a multi-SIM wireless communication device may be associated with the same or different PLMNs, each of which may have more than one wireless network. Each SIM is generally provisioned by a service provider with a list of preferred PLMNs from which the wireless communication device can receive service (e.g., a home PLMN and roaming partner PLMNs). In some embodiments, the wireless communication device processor may access non-volatile memory associated with a given one of the SIMs to identify supported radio access technologies, and the corresponding enabled frequency bands (and ARFCNs/UARFCNs/EUARFCNs/channels in each band).

In operation, once powered on and/or recovering from an out-of-service condition, a conventional wireless communication device (or modem stack associated with a SIM of a conventional multi-SIM wireless communication device) may begin an initial cell selection procedure if no information about the current wireless environment is stored in the wireless communication device. Otherwise, the wireless communication device typically starts a cell selection using a stored information cell-selection procedure. The wireless communication device may have stored the necessary information of the cell (such as frequency and scrambling code) when the wireless communication device was previously camped on the cell. Generally, the wireless communication device may first try to synchronize with that previous cell, and if synchronization fails, the wireless communication device may trigger the initial cell selection.

A conventional wireless communication device may first attempt to find PLMNs for one or more radio access technologies (e.g., GSM, UMTS, CDMA2000, LTE, etc.). To find PLMNs, the wireless communication device may perform a power scan on enabled frequency bands supported by the one or more radio access technologies to identify channels and measure signal strength for identified channels. The wireless communication device may identify those channels that are above a threshold signal strength and may attempt acquisition of each identified strong channel. Alternatively, the wireless communication device may use a list of stored carrier frequency information from previously received measurement and control information.

For each detected carrier frequency (i.e., acquired cell), the wireless communication device typically tunes to the frequency to read information to identify the associated network. For example, For example, in a GSM network, the wireless communication device may decode a synchronization channel (SCH) on the detected carrier frequency (i.e., acquired cell) to obtain a base station identity code (BSIC) and may read the broadcast control channel (BCCH) to obtain system information (e.g., a PLMN identifier).

For example, in UMTS systems, a conventional wireless communication device typically correlates the signal of the detected carrier frequency (i.e., acquired cell) to possible secondary synchronization codes to determine the correct code and obtain the frame synchronization on the corresponding secondary synchronization channel (S-SCH) and group identity. The wireless communication device may find the correct scrambling code, and detect the common control physical channel (CCPCH), which carries the system information including PLMN. In this manner, the wireless communication device may identify acquired cells in the wireless communication device's vicinity.

A conventional wireless communication device may select one of the PLMNs from those identified according to either an automatic mode or a manual mode. Once a PLMN has been selected, the wireless communication device may read system information of each acquired cell to obtain parameters, such as the PLMN identity and cell selection parameters. Such system information may also include RACH-related information, which may be read from the broadcast channel (BCH) and used in order to access RACH to initiate any of a number of procedures. Such procedures may include, for example, an initial call setup for a mobile terminating call and/or sending uplink data packets, a short message service message, etc.

For clarity, references to “first” and “second” SIMs, networks, and subscriptions are arbitrary used only for ease of reference, as at any given time the tune-away operation may be performed from either SIM/network/subscription to the other SIM/network/subscription. Thus, references to “first” and “second” are not intended to refer to a particular radio access technology, SIM, or network, nor to imply an order or priority among the various SIM/network/subscriptions.

While the techniques and embodiments described herein relate to a wireless communication device configured with at least one WCDMA/UMTS SIM and/or GSM SIM, the embodiment techniques may be extended to subscriptions on other radio access networks (e.g., 1×RTT/CDMA2000, Evolution Data Optimized (EV-DO), LTE, Worldwide Interoperability for Microwave Access (WiMAX), Wi-Fi, etc.). In that regard, the messages, physical and transport channels, radio control states, etc. referred to herein may also be known by other terms in various radio access technologies and standards. Further, the messages, channels, and control states may be associated with different timing in other radio access technologies and standards.

In various embodiments, an RF resource of a MSMS device may be configured to be shared between a plurality of SIMs, but may be employed by default to perform communications on a network enabled by a first SIM, such as a network capable of high-speed data communications (e.g., WCDMA, HSPA, LTE, etc.). As such, a modem stack associated with a second SIM of the device may often be in idle mode with respect to a second network. Depending on the radio access technology of the second network, such idle mode states may involve implementing a power saving mode that includes a cycle of sleep and awake states. For example, if the second network is a GSM network, during idle mode the modem stack associated with the second SIM may implement discontinuous reception (DRX).

Specifically, during a wake-up period (i.e., awake state), the timing of which may be set by the second network for a paging group to which the second SIM belongs, the modem stack associated with the second SIM may attempt to use the shared RF resource to monitor an access grant channel of the second network. During the sleep state, the modem stack may power off most processes and components, including the associated RF resource.

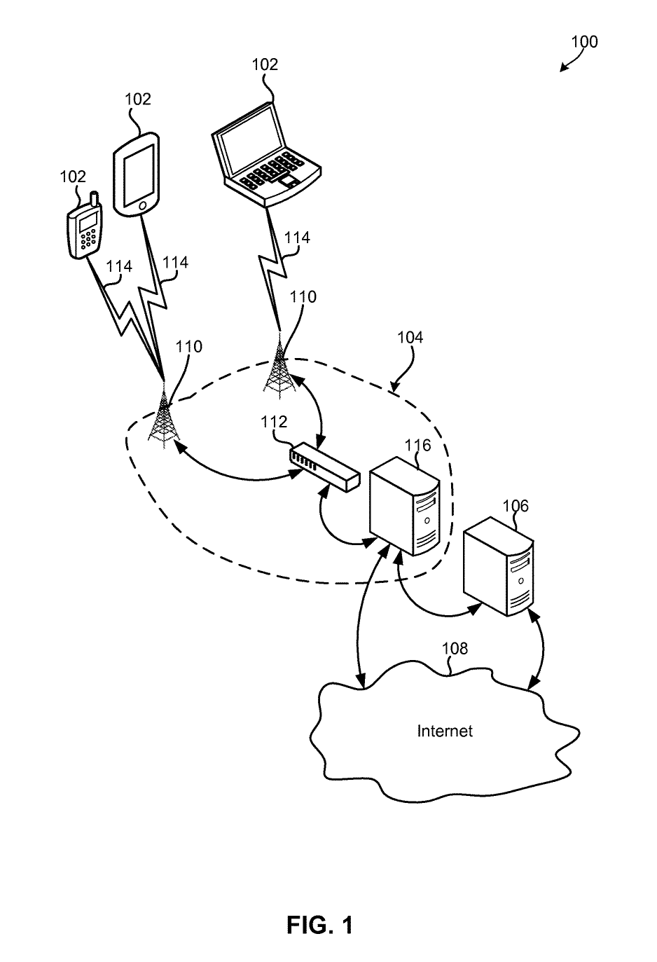

Various embodiments may be implemented within a variety of communication systems, such as the example communication system 100 illustrated in FIG. 1. The communication system 100 may include one or more wireless communication devices 102, a telephone network 104, and network servers 106 coupled to the telephone network 104 and to the Internet 108. In some embodiments, the network server 106 may be implemented as a server within the network infrastructure of the telephone network 104.

A typical telephone network 104 includes a plurality of cell base stations 110 coupled to a network operations center 112, which operates to connect voice and data calls between the wireless communication devices 102 (e.g., tablets, laptops, cellular phones, etc.) and other network destinations, such as via telephone land lines (e.g., a POTS network, not shown) and the Internet 108. The telephone network 104 may also include one or more servers 116 coupled to or within the network operations center 112 that provide a connection to the Internet 108 and/or to the network servers 106. Communications between the wireless communication devices 102 and the telephone network 104 may be accomplished via two-way wireless communication links 114, such as GSM, UMTS, EDGE, 4G, 3G, CDMA, TDMA, LTE, and/or other communication technologies.

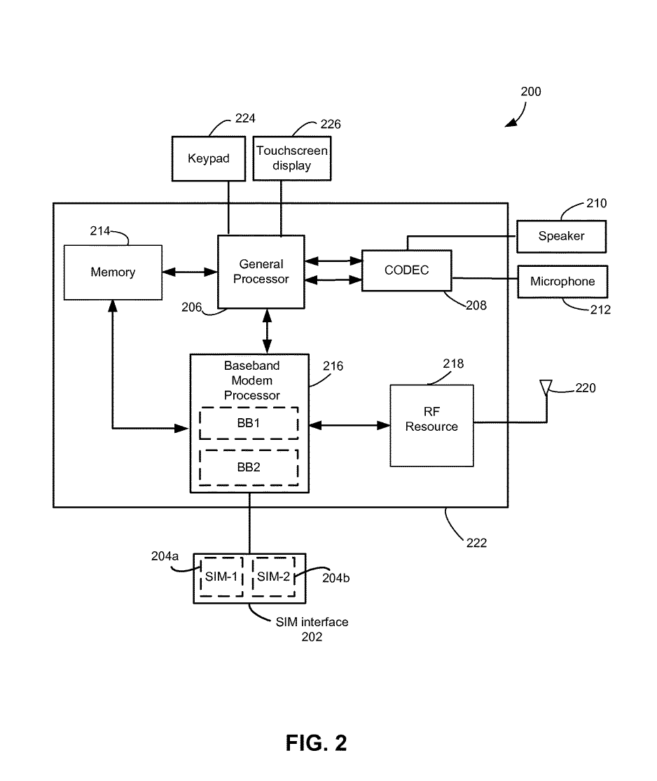

FIG. 2 is a functional block diagram of an example wireless communication device 200 that is suitable for implementing various embodiments. According to various embodiments, the wireless communication device 200 may be similar to one or more of the wireless communication devices 102 described with reference to FIG. 1.

With reference to FIGS. 1-2, in various embodiments, the wireless communication device 200 may be a single-SIM device. In other embodiments, the wireless communication device 200 may be a multi-SIM device, such as a multi-SIM multi-standby (MSMS) wireless communication device. In some embodiments, the wireless communication device 200 may be a dual-SIM dual-active (DSDA) wireless communication device. In other embodiments, the wireless communication device 200 may be a dual-SIM dual-standby (DSDS) wireless communication device.

The wireless communication device 200 may include at least one SIM interface 202, which may receive at least a first SIM (SIM-1) 204a associated with a first subscription and a second SIM (SIM-2) 204b that is associated with a second subscription. In some embodiments, the at least one SIM interface 202 may be implemented as multiple SIM interfaces 202, which may receive at least a second SIM (SIM-2) 204b that is associated with at least a second subscription.

A SIM in various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM 204a, 204b may have a CPU, ROM, RAM, EEPROM and I/O circuits. One or more of the first SIM 204a and second SIM 204b used in various embodiments may contain user account information, an IMSI a set of SIM application toolkit (SAT) commands and storage space for phone book contacts. One or more of the first SIM 204a and second SIM 204b may further store home identifiers (e.g., a System Identification Number (SID)/Network Identification Number (NID) pair, a Home PLMN (HPLMN) code, etc.) to indicate the SIM network operator provider. An Integrated Circuit Card Identity (ICCID) SIM serial number may be printed on one or more SIM 204 for identification.

The wireless communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The memory 214 may be a non-transitory tangible computer readable storage medium that stores processor-executable instructions. For example, the instructions may include routing communication data relating to a subscription though a corresponding baseband-RF resource chain. The memory 214 may store operating system (OS), as well as user application software and executable instructions.

The general-purpose processor 206 and the memory 214 may each be coupled to at least one baseband-modem processor 216. Each SIM 204a, 204b in the wireless communication device 200 may be associated with a baseband-RF resource chain that includes at least one baseband-modem processor 216 and at least one RF resource 218. In some embodiments, the wireless communication device 200 may be a DSDS device, with both SIMs 204a, 204b sharing a single baseband-RF resource chain that includes the baseband-modem processor 216 and the RF resource 218. In some embodiments, the shared baseband-RF resource chain may include, for each of the first SIM 204a and the second SIM 204b, separate baseband-modem processor 216 functionality (e.g., BB1 and BB2). The RF resource 218 may be coupled to at least one antenna 220, and the RF resource 218 may perform transmit/receive functions for the wireless services associated with each SIM 204a, 204b of the wireless communication device 200. The RF resource 218 may implement separate transmit and receive functionalities or may include a transceiver that combines transmitter and receiver functions.

In particular embodiments, the general-purpose processor 206, memory 214, baseband-modem processor 216, and RF resource 218 may be included in a system-on-chip device 222. The first and second SIMs 204a, 204b and their corresponding interface(s) 202 may be external to the system-on-chip device 222. Further, various input and output devices may be coupled to components of the system-on-chip device 222, such as interfaces or controllers. Example user input components suitable for use in the wireless communication device 200 may include, but are not limited to, a keypad 224 and a touchscreen display 226.

In some embodiments, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or to receive a telephone number. As another example, the request to initiate the outgoing call may be in the form of a voice command received via the microphone 212. Interfaces may be provided between the various software modules and functions in the wireless communication device 200 to enable communication between them, as is known in the art.

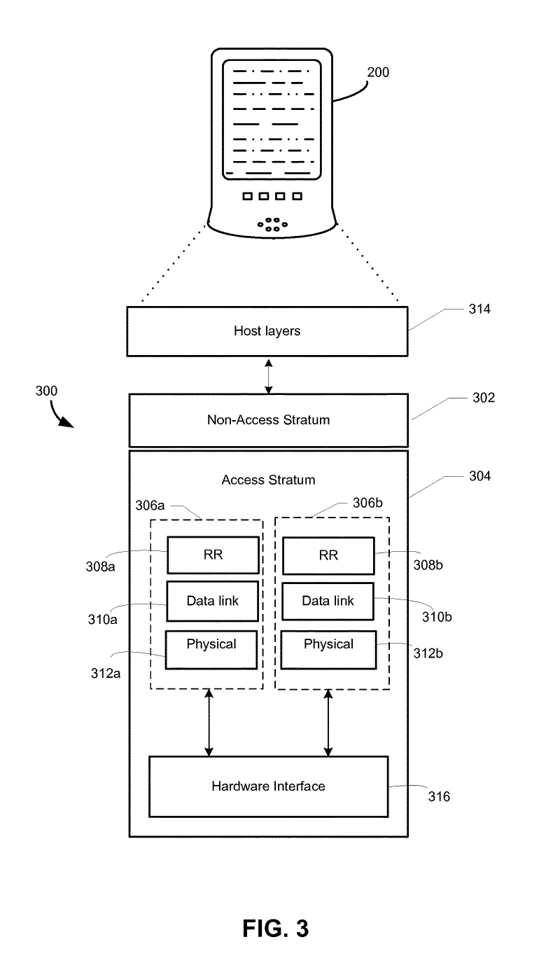

Referring to FIGS. 1-3, the wireless communication device 200 may have a layered software architecture 300 to communicate over access networks associated with SIMs. The software architecture 300 may be distributed among one or more processors, such as the baseband-modem processor 216. The software architecture 300 may also include a Non-Access Stratum (NAS) 302 and an Access Stratum (AS) 304. The NAS 302 may include functions and protocols to support traffic and signaling between SIMs of the wireless communication device 200 (e.g., first SIM/SIM-1 204a, second SIM/SIM-2 204b) and their respective core networks. The AS 304 may include functions and protocols that support communication between the SIMs (e.g., first SIM 204a, second SIM 204b) and entities of their respective access networks (such as a MSC if in a GSM network).

In the multi-SIM wireless communication device 200, the AS 304 may include multiple protocol stacks, each of which may be associated with a different SIM. For example, the AS 304 may include protocol stacks 306a, 306b, associated with the first and second SIMs 204a, 204b, respectively. Although described below with reference to GSM-type communication layers, protocol stacks 306a, 306b may support any of variety of standards and protocols for wireless communications. Each protocol stack 306a, 306b may respectively include Radio Resource management (RR) layers 308a, 308b. The RR layers 308a, 308b may be part of Layer 3 of a GSM signaling protocol and may oversee the establishment of a link between the wireless communication device 200 and associated access networks. In various embodiments, the NAS 302 and RR layers 308a, 308b may perform the various functions to search for wireless networks and to establish, maintain and terminate calls.

In some embodiments, each RR layer 308a, 308b may be one of a number of sub-layers of Layer 3. Other sub-layers may include, for example, connection management (CM) sub-layers (not shown) that route calls, select a service type, prioritize data, perform quality of service (QoS) functions, etc.

Residing below the RR layers 308a, 308b, the protocol stacks 306a, 306b may also respectively include data link layers 310a, 310b, which may be part of Layer 2 in a GSM signaling protocol. The data link layers 310a, 310b may provide functions to handle incoming and outgoing data across the network, such as dividing output data into data frames and analyzing incoming data to ensure the data has been successfully received. In some embodiments, each data link layer 310a, 310b may contain various sub-layers (e.g., media access control (MAC) and logical link control (LLC) layers (not shown)). Residing below the data link layers 310a, 310b, the protocol stacks 306a, 306b may also respectively include physical layers 312a, 312b, which may establish connections over the air interface and manage network resources for the wireless communication device 200.

While the protocol stacks 306a, 306b provide functions to transmit data through physical media, the software architecture 300 may further include at least one host layer 314 to provide data transfer services to various applications in the wireless communication device 200. In some embodiments, application-specific functions provided by the at least one host layer 314 may provide an interface between the protocol stacks 306a, 306b and the general-purpose processor 206. In alternative embodiments, the protocol stacks 306a, 306b may each include one or more higher logical layers (e.g., transport, session, presentation, application, etc.) that provide host layer functions. In some embodiments, the software architecture 300 may further include in the AS 304 a hardware interface 316 between the physical layers 312a, 312b and the communication hardware (e.g., one or more RF resource).

In various embodiments, the protocol stacks 306a, 306b of the layered software architecture may be implemented to allow modem operation using information provisioned on multiple SIMs. Therefore, a protocol stack that may be executed by a baseband-modem processor is interchangeably referred to herein as a modem stack.

Although described below with reference to UMTS-type and GSM-type communication layers, the modem stacks in various embodiments may support any of a variety of current and/or future protocols for wireless communications. For examples, the modem stacks in various embodiments may support networks using other radio access technologies described in 3GPP standards (e.g., Long Term Evolution (LTE), etc.), 3GPP2 standards (e.g., 1×RTT/CDMA2000, Evolved Data Optimized (EV-DO), Ultra Mobile Broadband (UMB), etc.) and/or IEEE standards Worldwide Interoperability for Microwave Access (WiMAX), Wi-Fi, etc.).

For clarity, while the techniques and embodiments described herein relate to a wireless communication device configured with at least one WCDMA/UMTS subscription, the embodiment techniques may be extended to subscriptions on other radio access networks (e.g., CDMA2000, GSM, EVDO, LTE, etc.).

In a conventional GSM system, a wireless communication device may attempt to be assigned a dedicated channel resource by sending a resource request message on the RACH to a base station of a network. For example, a wireless communication device (or modem stack associated with a SIM in the wireless communication device) may initiate a communication to another wireless communication device (e.g., a mobile terminating call, data session for transmitting and receiving packets, etc.) by requesting a connection to the network associated with that SIM.

The GSM standard employs a multiple access scheme that defines how simultaneous communication can occur between different wireless communication devices and base stations. Within each cell, a combination of frequency division multiple access (FDMA) and time division multiple access (TDMA) techniques are employed by the standard. Specifically, the available spectrum is divided into carrier frequencies of 200 kHz bandwidth, with pairs of carriers that are 45 MHz apart from each other identified by an absolute radio-frequency channel number (ARFCN). Each pair of carrier frequencies (one uplink, one downlink) is also divided into eight time slots (e.g., TS0 through TS7) using TDMA such that eight consecutive time slots form one TDMA frame, lasting approximately 4.615 ms. In this manner individual physical channels may be formed, each of which correspond to a particular carrier frequency and time slot number.

Logical channels may be mapped to the physical channels, and categorized by the information carried. Specifically, control channels may carry signaling or synchronization data to or from group including a particular wireless communication device (or modem stack associated with a SIM of the device). In various embodiments, a wireless communication device may be assigned a time slot in which the group including the device may receive messages on TDMA frames carrying common control channels. Therefore, the wireless communication device may be configured to receive and decode only the bursts within that timeslot, which is repeated after the other seven time slots of the TDMA frame (e.g., totally around 4.03 ms).

Mechanisms for establishing and assigning a dedicated channel for communications in GSM are radio resource establishment procedures specified in Section 3.3 of 3GPP TS 04.08 entitled “Digital cellular telecommunications system (Phase 2+); Mobile radio interface layer 3 specification (Release 1999).” This procedure uses the CCCH (paging channel (PCH) and AGCH) as a unicast downlink and the RACH as a shared uplink.

In order to initiate a mobile originating call, a modem stack associated with a SIM of the wireless communication device may send a channel request message on the RACH. The request on the RACH may be a burst that encodes an 8-bit transaction tag and the BSIC of the serving base station. A variable number of most-significant bits in the tag encode the reason for the access request, with the remaining bits chosen randomly. Similarly, in order to initiate sending data packets to the network, the wireless communication device may send a request for network access in GPRS on the RACH to the first network.

In response to the RACH, the network may grant access to the network by supplying details of a dedicated channel, or deny access by sending a rejection. Specifically, to grant access, an immediate assignment (IA) message may be sent from the network to the SIM of the wireless communication device on the AGCH. The IA message contains the details of a dedicated channel, such as a standalone dedicated control channel (SDCCH) to be used for subsequent communications, including the channel number and a first timing advance value. For a data session, the IA message may contain information about a packet data traffic channel (PDTCH) resource that the SIM is allowed to use in the uplink. The network may also assign resources in the downlink direction if there is data to be sent to the wireless communication device.

To deny access to the SIM, such as when no dedicated channel or PDTCH resource is available for assignment, an IA rejection message may be sent to the SIM on the AGCH. The IA rejection message may contain a hold-off time for the next access attempt. If the RACH request is not answered with an assignment or rejection within a given timeout period (e.g., around 0.5 seconds), the modem stack associated with the SIM may send another RACH request after a small random delay. This cycle may be repeated 6-8 times before the modem stack associate with the SIM aborts the access attempt.

The modem stack associated with the SIM may receive data on the paging channel for monitoring whether the network requests contact with the SIM. For example, for a mobile terminating call in GSM, or if there is downlink data to be transmitted to the SIM that is not in a ready state in GPRS, the modem stack associated with the SIM may receive a paging message. The paging message may include the identity number (IMSI) associated with the SIM or a temporary number (TMSI).

As discussed, in a MSMS wireless communication device configured with a RF resource shared by all SIMs, modem stacks associated with multiple SIMs may be in idle mode simultaneously, but only communication may be enabled on only one modem stack at a time. During an active data communication on a modem stack associated with a first SIM, the RF resource may be tuned to a first network (e.g., WCDMA/UMTS network) for sending and/or receiving data packets. A request to initiate a mobile originating call or uplink data transmission on a modem stack associated with a second SIM may be detected based on a RACH sent to a second network (e.g., a GSM network). Conventionally, the active communication on the modem stack associated with the first SIM may be paused to allow the second SIM to tune away to the second network for receiving bursts on the downlink CCCH frames in order to monitor an AGCH for an IA message or an IA rejection. While such monitoring typically occurs only for a particular timeslot assigned to the second SIM group, the RF resource typically remains tuned to the second network until a message is recovered. Therefore, the AGCH monitoring may last for an indefinite duration, the length of which may also be affected by radio signal conditions, available network resource, etc.

Further, once an IA message granting access is received, the actual call or data transmission on the modem stack associated with the second SIM can extend the duration of the data suspension on the modem stack associated with the first SIM. Conventionally, the first network may set an expiration timer for the paused data communication on the first SIM. Upon expiration, if the shared RF resource has not been relinquished back to the data communication on the modem stack associated with the first SIM, the data communication is dropped by the first network. Such extended use of the RF resource by the modem stack associated with the second SIM is wasted when, for example, the received burst do not encode a message on the AGCH, but instead form a message on another CCCH (e.g., a paging message on the PCH). Similarly, such extended use of the RF resource is wasted when the received bursts encode a message on the AGCH, but is an IA message addressed to a different wireless communication device. Further, such extended use of the RF resource is wasted when the received bursts encodes a message on the AGCH that is intended for (i.e., addressed to) to the second SIM, but is an IA rejection, and therefore no communication on the second SIM is started.

Moreover, a message sent on the AGCH may transmitted over a combination of up to four consecutive TDMA frames, the bursts are typically used to decode a message on the downlink CCCH. Since each wireless communication device or SIM only decodes data bursts in one out of the eight timeslot in each downlink TDMA frame, recovering a message from data sent on the AGCH generally involves a tune-away by the RF resource for a duration of at least 18.46 ms (i.e., four TDMA frames, or a total of 32 timeslots).

In various embodiments, efficient use of the shared RF resource may be improved in order to maintain performance on the data communication in the first network supported by the first SIM. First, in various embodiments, quick burst tune-away (QBTA) gaps may be created in the data session of the modem stack associated with the first SIM. That is, the RF resource may employ burst-level tune-aways from the first network to the second network for decoding data in the assigned timeslot of downlink TDMA frames with a CCCH.

Employing such QBTA gaps may allow the wireless communication device to perform short duration decoding procedures with minimal impact to the throughput of the data communication on the modem stack associated with the first SIM. Specifically, tuning away from the first network to the second network and tuning back to the first network may occur at the burst level, on a slot-by-slot basis. For example, the wireless communication device may tune away from the first network in one burst, read the downlink CCCH from the second network in a second burst, and tune back to the first network in a third burst.

In some embodiments, the QBTA gap in the data communication may prevent the normal immediate suspension of the data communication on the first network supported by the first SIM. In this manner, the first SIM data communication may be able to use the RF resource during the periods in which the second SIM would normally be tuned to the second network but not decoding data bursts. That is, the time periods between repetitions of a particular assigned timeslot in consecutive TDMA frames (e.g., around 4 ms each). Therefore, bursts are individually evaluated in order to require the least amount of decoding and time delay prior to returning the shared RF resource to the data com

In various embodiments, if a signal-to-noise ratio (SNR) is greater than a threshold (e.g., 10 dB) or greater than a tolerance of the threshold, such as about 10 dB (e.g., greater than some value between 9 and 11 dB), the wireless communication device may determine whether the decoded first burst is part of a paging request based on the values in fields classifying messaging services in layer 3 of the modem stack associated with the second SIM (e.g., radio resource management, mobility management, call control, supplemental services, etc.). For example, in a GSM network, such messaging service classification fields may include a skip indicator, a protocol discriminator, and message type identified in two 8-bit header fields. If these fields indicate that the decoded burst is part of a radio resource management service message that is a paging request, the wireless communication device may exclude the remainder of that message by stopping receiving and decoding the remaining 1-3 bursts. Instead, the wireless communication device may tune the RF resource back to the data communication on the first network and remain tuned to the first network until the next anticipated opportunity for an AGCH message on the second network. If the SNR for receiving the burst was not greater than a threshold of 10 dB (or greater than a tolerance of the threshold, such as some value between 9 and 11 dB) and/or the decoded burst is not identified as a paging message, then the RF resource may be tuned back to the data communication on the first network until the next QBTA gap.

Further, various embodiments may leverage good RF conditions (i.e., RF conditions that exceed certain link quality or QoS level(s)) on the second network to allow the wireless communication device to decode a message on the AGCH in fewer than four bursts. Once the entire message has been recovered from the decoded data bursts, the wireless communication device may skip decoding of any remaining bursts of the message. If the recovered message is anything other than an AGCH message addressed to the second SIM, the wireless communication device may tune the RF resource back to the data communication on the first network, remaining tuned to the first network until the next anticipated opportunity for an AGCH message on the second network. If the message is an AGCH message for the second SIM (e.g., an IA message or IA rejection), the wireless communication device may then suspend the data communication on the first network to proceed with the requested communication activity on the second SIM.

In this manner, decoding a CCCH for the second SIM may be halted when the message being sent from the second network is identified as being irrelevant or when the additional data bursts are unnecessary. Combined with the use of QBTA gaps, the selective receiving and decoding of data enables the shared RF resource to be used for longer continuous time periods by the active data communication on the first network, thereby improving performance on the first SIM.

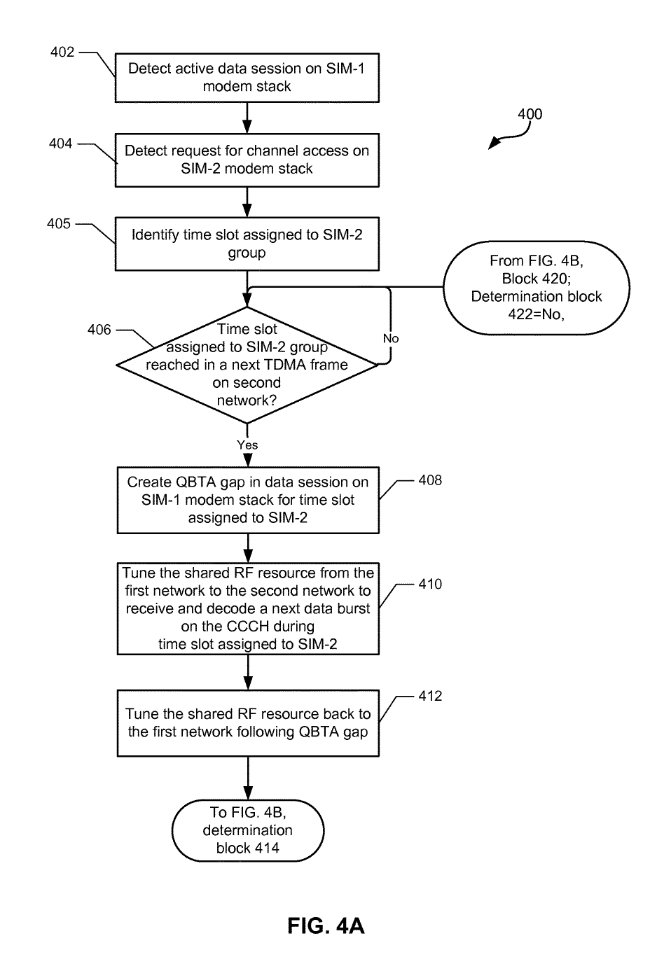

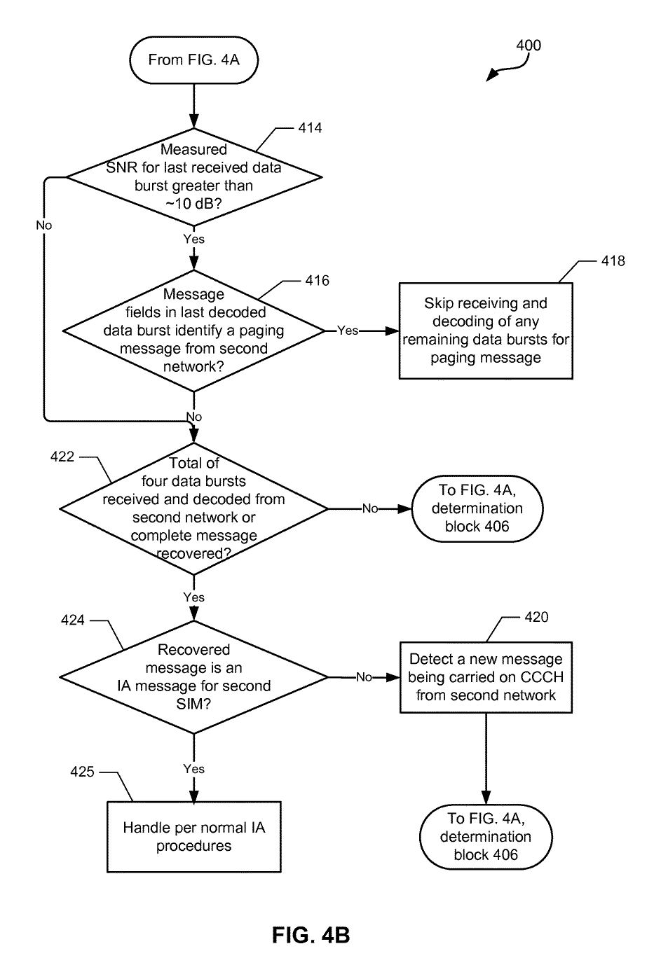

FIGS. 4A and 4B illustrate a method 400 for improving throughput on an active data communication in a first network supported by a first SIM while enabling tune-aways for receiving and decoding an AGCH message from a second network supported by a second SIM of a multi-SIM multi-standby wireless communication device (e.g., 102, 200 in FIGS. 1-3) according to some embodiments. With reference to FIGS. 1-4B, the multi-SIM multi-standby device may be configured with a single shared RF resource (e.g., 218). In various embodiments, the operations of the method 400 may be implemented by one or more processors of the wireless communication device, such as a general-purpose processor (e.g., 206) and/or baseband-modem processor (e.g., 216). In various embodiments, the operations of the method 400 may be implemented by a separate controller (not shown) that may be coupled to memory (e.g., 214) and to the one or more processors.

In block 402, the wireless communication device processor may detect that a modem stack associated with a first SIM (“SIM-1”) is participating in an active data session on a first network supported by the first SIM. In some embodiments, the data session may involve sending and/or receiving data packets to the first network using one or more of a variety of radio access technologies (e.g., WCDMA/UMTS, EDGE, LTE, etc.)

In block 404, the wireless communication device processor may detect a request for channel access on a modem stack associated with a second SIM. In some embodiments, the modem stack associated with the second SIM may currently be camped in idle mode on a second network supported by the second SIM. The request for channel access may be performed by sending a request to the second network on the RACH using the shared RF resource (e.g., 218) as described. The channel access may be requested, for example, as result of receiving input indicating a desire to start a mobile imitated voice call on the second network (e.g., keypad input from the user, etc.), or to start an uplink packet data and/or an SMS message communication to the second network.

In some embodiments, the request for channel access may be detected because of a notification triggered from signaling in the second SIM modem stack preparing to send the RACH request. In some embodiments, the notification may be triggered directly from the sending of the uplink RACH transmission itself and/or from user input indicating the desired activity on the modem stack associated with the second SIM. In various embodiments, the shared RF resource may be used to send the RACH request to the second network at a convenient time with respect to activities on the modem stack associated with the first SIM. Regardless of when the request is sent, in various embodiments, the shared RF resource may tune back to the first network following the RACH transmission.

In block 405, the wireless communication device processor may identify a time slot assigned to a group including the second SIM. For example, during the assigned time slot, a message on a common control channel may be received from a second network supported by the second SIM. In determination block 406, the wireless communication device processor may determine whether the time slot assigned to a group including the second SIM has been reached in a next TDMA frame on the second network. So long as the time slot assigned to the group including the second SIM has not been reached in the next TDMA frame (i.e., determination block 406=“No”), the wireless communication device processor may continue to determine whether the time slot assigned to the group including the second SIM has been reached, while remaining tuned to the first network.

In response to determining that the time slot assigned to the group including the second SIM has been reached in the next TDMA frame on the second network (i.e., determination block 406=“Yes”), the wireless communication device processor may create a quick burst tune-away gap (QBTA) gap for the data session on the modem stack associated with the first SIM, in block 408. The QBTA gap may correspond to the time slot assigned to the group including the second SIM on the second network.

In block 410, the wireless communication device processor may tune the shared RF resource from the first network to the second network to receive and decode a next data burst on the CCCH during the assigned time slot.

In various embodiments, receiving the (next) data burst on the CCCH may include measuring the signal-to-noise ratio (SNR) of the communication link with the second network. In block 412, the wireless communication device processor may tune back to the first network following the QBTA gap. In various embodiments, after each QBTA gap, the wireless communication device processor may determine whether a message granting or denying the channel access request (e.g., an IA message intended for the second SIM) can be recovered or excluded based on the data that has been received and decoded. Specifically, in determination block 414, the wireless communication device processor may determine whether the measured SNR for the last data burst received on the second network (e.g., as received in block 410) was greater than about 10 dB (e.g., greater that 9 to 11 dB).

In response to determining that the measured SNR for the last data burst received on the second network was greater than about 10 dB (i.e., determination block 414=“Yes”), the wireless communication device processor may determine whether message fields in the last decoded data burst identify a paging message from the second network, in determination block 416. For example, as discussed for a GSM network, the wireless communication device processor may identify second and third 8-bit message fields in the decoded burst and determine whether the values match those used to classify any of the paging message types 1-3.

In response to determining that the message fields in the last decoded data burst identify the message as a paging message from the second network (i.e., determination block 416=“Yes”), the wireless communication device processor may skip receiving and decoding of any remaining data bursts for that message in block 418. That is, the wireless communication device processor may remain tuned to the first network during subsequent TDMA frames carrying the paging message in the assigned time slot. In some embodiments, the number of remaining data bursts for the paging message may be identified or assumed based on the total number of data bursts of that message that were decoded by the wireless communication device processor before the message was identified as a paging message. For example, if the paging message is identified from receiving and decoding one burst, the wireless communication device processor may assume that the paging message will be carried in bursts on the CCCH in the next three TDMA frames, based on the maximum of four bursts used to transmit a paging message in GSM.

In response to determining that the measured SNR of the communication link with the second network was not greater than about 10 dB (i.e., determination block 414=“No”) or that the message fields in the last decoded data burst do not identify a paging message from the second network (i.e., determination block 416=“No”), the wireless communication device processor may determine whether (i) a total of four data bursts have been received and decoded on the CCCH from the second network or (ii) a complete message has been recovered from the second network, in determination block 422.

In response to determining that (i) less than four data bursts have been received and decoded on the CCCH from the second network and (ii) a complete message has not been recovered from the second network (i.e., determination block 422=“No”), the wireless communication device processor may again determine whether the time slot assigned to the group including the second SIM has been reached in the next TDMA frame on the second network in determination block 406 (FIG. 4A).

In response to determining that a total of four data bursts have been received and decoded on the CCCH from the second network or that a complete message has been recovered from the data bursts received and decoded on the CCCH from the second network (i.e., determination block 422=“Yes”), the wireless communication device processor may determine whether the message is an IA message that is intended for the second SIM, in determination block 424. The IA message intended for the second SIM may be, for example, an IA message that provides the requested channel access or an IA rejection that denies the requested access.

In response to determining that the recovered message is an IA message that is intended for the second SIM (i.e., determination block 424=“Yes”), the wireless communication device processor may handle the message according to normal IA procedures of GSM, in block 425. For example, for an IA message, the data session on the first network may be suspended and the shared RF resource may be tuned to the second network for communication using the granted resource. For an IA rejection, the wireless communication device may restart the channel access attempt (e.g., a new RACH request) following a hold-off time that may be specified in the rejection.

In response to determining that the recovered message is not an IA message that is intended for the second SIM (i.e., determination block 424=“No”), the wireless communication device processor may detect that a new message is being carried on the CCCH from the second network, in block 420. As described, this detecting may also be made using a count of TDMA frames and the maximum of four bursts used to transmit a paging message in GSM. Upon detecting that a new message is being carried on the CCCH from the second network, the wireless communication device processor may again determine whether the time slot assigned to the group including the second SIM has been reached in the next TDMA frame on the second network in determination block 406 (FIG. 4A).

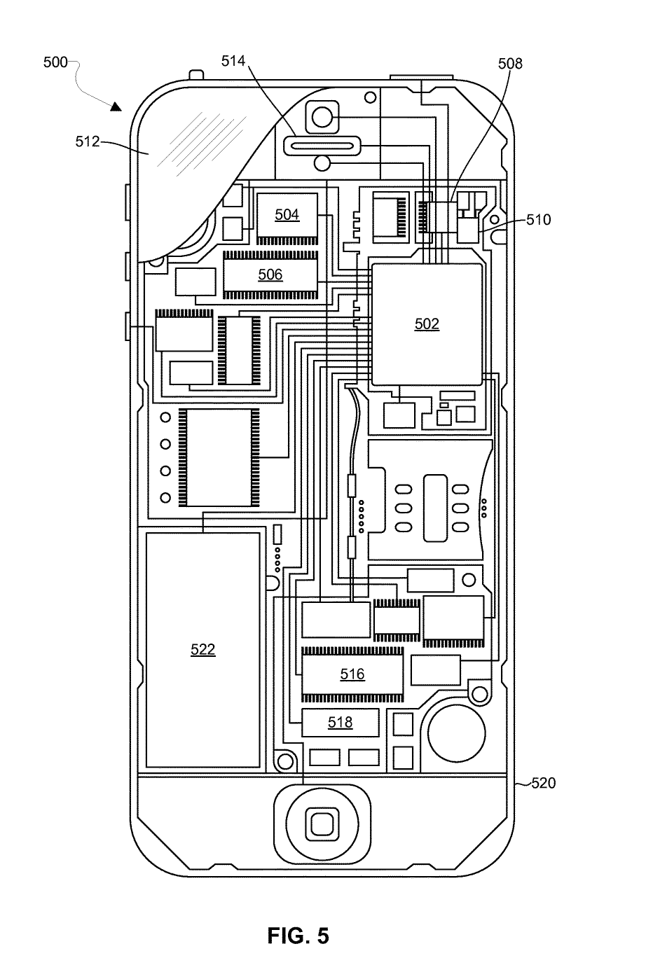

Various embodiments may be implemented in any of a variety of wireless communication devices, an example of which is illustrated in FIG. 5. For example, With reference to FIGS. 1-5, a wireless communication device 500 (which may correspond, for example, the wireless communication devices 102, 200 in FIGS. 1-2) may include a processor 502 coupled to a touchscreen controller 504 and an internal memory 506. The processor 502 may be one or more multicore integrated circuits (ICs) designated for general or specific processing tasks. The internal memory 506 may be volatile or non-volatile memory, and may also be secure and/or encrypted memory, or unsecure and/or unencrypted memory, or any combination thereof.

The touchscreen controller 504 and the processor 502 may also be coupled to a touchscreen panel 512, such as a resistive-sensing touchscreen, capacitive-sensing touchscreen, infrared sensing touchscreen, etc. The wireless communication device 500 may have one or more radio signal transceivers 508 (e.g., Peanut®, Bluetooth®, Zigbee®, Wi-Fi, RF radio) and antennae 510, for sending and receiving, coupled to each other and/or to the processor 502. The transceivers 508 and antennae 510 may be used with the above-mentioned circuitry to implement the various wireless transmission protocol stacks and interfaces. The wireless communication device 500 may include a cellular network wireless modem chip 516 that enables communication via a cellular network and is coupled to the processor. The wireless communication device 500 may include a peripheral device connection interface 518 coupled to the processor 502. The peripheral device connection interface 518 may be singularly configured to accept one type of connection, or multiply configured to accept various types of physical and communication connections, common or proprietary, such as USB, FireWire, Thunderbolt, or PCIe. The peripheral device connection interface 518 may also be coupled to a similarly configured peripheral device connection port (not shown). The wireless communication device 500 may also include speakers 514 for providing audio outputs. The wireless communication device 500 may also include a housing 520, constructed of a plastic, metal, or a combination of materials, for containing all or some of the components discussed herein. The wireless communication device 500 may include a power source 522 coupled to the processor 502, such as a disposable or rechargeable battery. The rechargeable battery may also be coupled to the peripheral device connection port to receive a charging current from a source external to the wireless communication device 500.

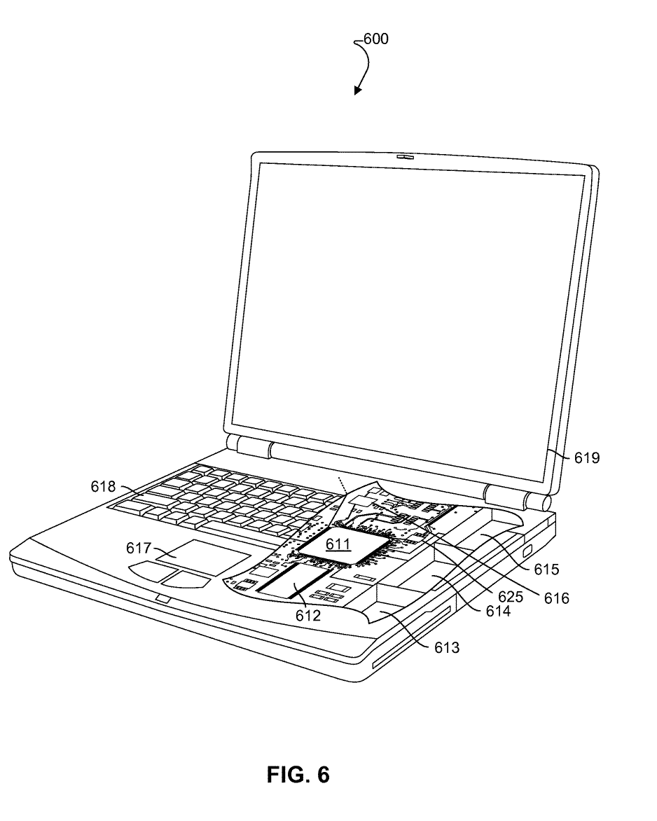

Various embodiments described above may also be implemented within a variety of personal computing devices, such as a laptop computer 600 (which may correspond, for example, the wireless communication devices 102,200 in FIGS. 1-2) as illustrated in FIG. 6. With reference to FIGS. 1-6, many laptop computers include a touchpad touch surface 617 that serves as the computer's pointing device, and thus may receive drag, scroll, and flick gestures similar to those implemented on wireless computing devices equipped with a touch screen display and described above. The laptop computer 600 will typically include a processor 611 coupled to volatile memory 612 and a large capacity nonvolatile memory, such as a disk drive 613 of Flash memory. The laptop computer 600 may also include a floppy disc drive 614 and a compact disc (CD) drive 615 coupled to the processor 611. The laptop computer 600 may also include a number of connector ports coupled to the processor 611 for establishing data connections or receiving external memory devices, such as a USB or FireWire® connector sockets, or other network connection circuits for coupling the processor 611 to a network. In a notebook configuration, the computer housing includes the touchpad touch surface 617, the keyboard 618, and the display 619 all coupled to the processor 611. Other configurations of the computing device may include a computer mouse or trackball coupled to the processor (e.g., via a USB input) as are well known, which may also be used in conjunction with various embodiments.

The processors 502 and 611 may be any programmable microprocessor, microcomputer or multiple processor chip or chips that can be configured by software instructions (applications) to perform a variety of functions, including the functions of various embodiments described above. In some devices, multiple processors may be provided, such as one processor dedicated to wireless communication functions and one processor dedicated to running other applications. Typically, software applications may be stored in the internal memory 506, 612, and 613 before they are accessed and loaded into the processors 502 and 611. The processors 502 and 611 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 502, 611, including internal memory or removable memory plugged into the device and memory within the processor 502 and 611, themselves.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a SIM and data receiving associated with a different SIM, such identifiers are merely for convenience and are not meant to limit various embodiments to a particular order, sequence, type of network or carrier.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiment, the functions described may be implemented in hardware, software, firmware, or any combination thereof If implemented in software, the functions may be stored as one or more instructions or code on a non-transitory computer-readable medium or non-transitory processor-readable medium. The operations of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present invention is not intended to be limited to the embodiments shown herein but is to be accorded the widest scope consistent with the following claims and the principles and novel features disclosed herein.

What is claimed is:

1. A method of improving data throughput of a multi-subscriber identity module (SIM) wireless communication device having at least a first SIM and a second SIM, the method comprising:
detecting an active data communication in a first network on a modem stack associated with the first SIM;
detecting a channel access request on a modem stack associated with the second SIM;
identifying an assigned time slot for receiving a message on a common control channel from a second network supported by the second SIM;
tuning to the second network to receive and decode data during the assigned time slot in at least one frame capable of carrying the common control channel;
tuning back to the first network following the assigned time slot in each of the at least one frame; and
determining, after each assigned time slot, whether a message granting or denying the channel access request can be recovered or excluded based on the data that has been received and decoded.

2. The method of claim 1, further comprising:
skipping receiving and decoding of remaining frames of the message on the common control channel in response to determining that a message granting the channel access request can be excluded; and
stopping tuning to the first network in response to determining that a message granting the channel access request is recovered.

3. The method of claim 1, wherein:
determining whether the message can be excluded comprises:
determining whether a signal-to-noise ratio for at least one received data burst is greater than 10 dB; and
determining whether the data that has been received and decoded can be identified as part of a paging message in response to determining that the signal-to-noise ratio for the at least one received data burst is greater than 10 dB; and
the method further comprises repeating the receiving and decoding of data for a next frame capable of carrying the common control channel in response to determining that the signal-to-noise ratio for the at least one received data burst is not greater than 10 dB or that the data that has been received and decoded is not identified as part of a paging message.

4. The method of claim 3, wherein determining whether the data that has been received and decoded can be identified as part of a paging message comprises:
identifying information provided in message fields in the data that has been received and decoded; and
comparing the identified information to values classifying at least one paging message type.

5. The method of claim 4, wherein:
the message fields comprise a skip indicator, a protocol discriminator, and a message type; and
the values classifying the at least one paging message type include a first 8-bit value identifying radio resource management communications, and a second 8-bit value identifying one of a paging message type 1-3.

6. The method of claim 1, wherein detecting a channel access request on a modem stack associated with the second SIM comprises detecting transmission of a request on a random access channel (RACH) to the second network.

7. The method of claim 1, wherein the message granting the channel access request is an immediate assignment (IA) message received on an access grant control channel from the second network.

8. The method of claim 1, wherein the message denying the channel access request is an immediate assignment (IA) rejection message received on an access grant control channel from the second network.

9. The method of claim 1, wherein the at least one frame capable of carrying the common control channel comprises one to four time division multiple access (TDMA) frames.

10. A wireless communication device, comprising:
a memory;
a shared radio frequency (RF) resource; and
a processor coupled to the memory and the shared RF resource, configured to connect to a first SIM and a second SIM, and configured with processor-executable instructions to:
detect an active data communication in a first network on a modem stack associated with the first SIM;
detect a channel access request on a modem stack associated with the second SIM;
identify an assigned time slot for receiving a message on a common control channel from a second network supported by the second SIM;
tune the shared RF resource to the second network to receive and decode data during the assigned time slot in at least one frame capable of carrying the common control channel;
tune the shared RF resource back to the first network following the assigned time slot in each of the at least one frame; and
determine, after each assigned time slot, whether a message granting or denying the channel access request can be recovered or excluded based on the data that has been received and decoded.

11. The wireless communication device of claim 10, wherein the processor is further configured with processor-executable instruction to:
skip receiving and decoding of remaining frames of the message on the common control channel in response to determining that a message granting the channel access request can be excluded; and
stop tuning the shared RF resource to the first network in response to determining that a message granting the channel access request is recovered.

12. The wireless communication device of claim 10, wherein the processor is further configured with processor-executable instructions to:
determine whether the message can be excluded by:
determining whether a signal-to-noise ratio for at least one received data burst is greater than 10 dB; and
determining whether the data that has been received and decoded can be identified as part of a paging message in response to determining that the signal-to-noise ratio for the at least one received data burst is greater than 10 dB; and
repeat the receiving and decoding of data for a next frame capable of carrying the common control channel in response to determining that the signal-to-noise ratio for the at least one received data burst is not greater than 10 dB or that the data that has been received and decoded is not identified as part of a paging message.

13. The wireless communication device of claim 12, wherein the processor is further configured with processor-executable instruction to determine whether the data that has been received and decoded can be identified as part of a paging message by:
identifying information provided in message fields in the data that has been received and decoded; and
comparing the identified information to values classifying at least one paging message type.

14. The wireless communication device of claim 13, wherein:
the message fields comprise a skip indicator, a protocol discriminator, and a message type; and
the values classifying the at least one paging message type include a first 8-bit value identifying radio resource management communications, and a second 8-bit value identifying one of a paging message type 1-3.

15. The wireless communication device of claim 10, wherein the processor is further configured with processor-executable instruction to detect a channel access request on a modem stack associated with the second SIM by detecting transmission of a request on a random access channel (RACH) to the second network.

16. The wireless communication device of claim 10, wherein the message granting the channel access request is an immediate assignment (IA) message received on an access grant control channel from the second network.

17. The wireless communication device of claim 10, wherein the message denying the channel access request is an IA rejection message received on an access grant control channel from the second network.

18. The wireless communication device of claim 10, wherein the at least one frame capable of carrying the common control channel comprises one to four time division multiple access (TDMA) frames.

19. A wireless communication device, comprising:
a shared radio frequency (RF) resource;
means for detecting an active data communication in a first network on a modem stack associated with a first SIM;
means for detecting a channel access request on a modem stack associated with a second SIM;
means for identifying an assigned time slot for receiving a message on a common control channel from a second network supported by the second SIM;
means for tuning the shared RF resource to the second network to receive and decode data during the assigned time slot in at least one frame capable of carrying the common control channel;
means for tuning the shared RF resource back to the first network following the assigned time slot in each of the at least one frame; and
means for determining, after each assigned time slot, whether a message granting or denying the channel access request can be recovered or excluded based on the data that has been received and decoded.

20. A non-transitory processor-readable storage medium having stored thereon processor-executable instructions configured to cause a processor of a wireless communication device to perform operations comprising:
detecting an active data communication in a first network on a modem stack associated with a first SIM;
detecting a channel access request on a modem stack associated with a second SIM;
identifying an assigned time slot for receiving a message on a common control channel from a second network supported by the second SIM;
tuning a shared radio frequency (RF) resource to the second network to receive and decode data during the assigned time slot in at least one frame capable of carrying the common control channel;
tuning the shared RF resource back to the first network following the assigned time slot in each of the at least one frame; and
determining, after each assigned time slot, whether a message granting or denying the channel access request can be recovered or excluded based on the data that has been received and decoded.

21. The non-transitory processor-readable storage medium of claim 20, wherein the stored processor-executable instructions are configured to cause the processor of the wireless communication device to perform operations further comprising:
skipping receiving and decoding of remaining frames of the message on the common control channel in response to determining that a message granting the channel access request can be excluded; and
stopping tuning the shared RF resource to the first network in response to determining that a message granting the channel access request is recovered.

22. The non-transitory processor-readable storage medium of claim 20, wherein:
the stored processor-executable instructions are configured to cause the processor of the wireless communication device to perform operations such that determining whether the message can be excluded comprises:
determining whether a signal-to-noise ratio for at least one received data burst is greater than 10 dB; and
determining whether the data that has been received and decoded can be identified as part of a paging message in response to determining that the signal-to-noise ratio for the at least one received data burst is greater than 10 dB; and
the stored processor-executable instructions are configured to cause the processor of the wireless communication device to perform operations further comprising repeating the receiving and decoding of data for a next frame capable of carrying the common control channel in response to determining that the signal-to-noise ratio for the at least one received data burst is not at least 10 dB, or that the data that has been received and decoded is not identified as part of a paging message.

23. The non-transitory processor-readable storage medium of claim 22, wherein the stored processor-executable instructions are configured to cause the processor of the wireless communication device to perform operations such that determining whether the data that has been received and decoded can be identified as part of a paging message comprises:
identifying information provided in message fields in the data that has been received and decoded; and
comparing the identified information to values classifying at least one paging message type.

24. The non-transitory processor-readable storage medium of claim 23, wherein the stored processor-executable instructions are configured to cause the processor of the wireless communication device to perform operations such that:
the message fields comprise a skip indicator, a protocol discriminator, and a message type; and
the values classifying the at least one paging message type include a first 8-bit value identifying radio resource management communications, and a second 8-bit value identifying one of a paging message type 1-3.

25. The non-transitory processor-readable storage medium of claim 20, wherein the stored processor-executable instructions are configured to cause the processor of the wireless communication device to perform operations such that detecting a channel access request on a modem stack associated with the second SIM comprises detecting transmission of a request on a random access channel (RACH) to the second network.

26. The non-transitory processor-readable storage medium of claim 20, wherein the stored processor-executable instructions are configured to cause the processor of the wireless communication device to perform operations such that a message granting or denying the channel access request is an immediate assignment (IA) message received on an access grant control channel from the second network.

27. The non-transitory processor-readable storage medium of claim 20, wherein the stored processor-executable instructions are configured to cause the processor of the wireless communication device to perform operations such that the at least one frame capable of carrying the common control channel comprises one to four time division multiple access (TDMA) frames.
